(19) United States
(12) Patent Application Publication
(10) Pub. No.: US 2024/0265823 A1
(43) Pub. Date: Aug. 8, 2024

(54) TEACHING MATERIAL EVALUATION SYSTEM AND TEACHING MATERIAL EVALUATION METHOD

(71) Applicant: Toyota Jidosha Kabushiki Kaisha, Toyota-shi (JP)

(72) Inventor: Kenji Ojima, Nagoya-shi (JP)

(73) Assignee: Toyota Jidosha Kabushiki Kaisha, Toyota-shi (JP)

(21) Appl. No.: 18/406,359

(22) Filed: Jan. 8, 2024

(30) Foreign Application Priority Data
Feb. 6, 2023 (JP) 2023-016204

(51) Int. Cl. G09B 5/06; G06F 3/01

(52) U.S. Cl. CPC G09B 5/06; G06F 3/013

(57) ABSTRACT

A teaching material evaluation system for evaluating a teaching material displayed on a display includes: a memory storing arrangement information, the arrangement information being information regarding an arrangement of a plurality of components included in the teaching material on the display; a detector configured to detect a viewpoint of a learner on the display for a period in which the teaching material is displayed on the display; and an evaluation unit configured to evaluate the teaching material using a detection result of the viewpoint and the arrangement information.

### CROSS REFERENCE TO RELATED APPLICATIONS

This application claims priority to Japanese Patent Application No. 2023-016204, filed Feb. 6, 2023, the disclosure of which is incorporated by reference herein in its entirety.

### BACKGROUND

### Field

The present disclosure relates to a teaching material evaluation system and a teaching material evaluation method.

### Related Art

Using the playback speed selected by the learner at the time of viewing the electronic teaching material, a technique for evaluating the difficulty of the electronic teaching material is known (e.g., Patent Literature 1).

Patent Literature 1: JP-2015-011290 A

If the learner did not view the teaching material being played back, there is a possibility that the teaching material could not be properly evaluated even if the teaching material was evaluated using the playback speed.

### SUMMARY

One aspect of the present disclosure provides a teaching material evaluation system for evaluating a teaching material displayed on a display. The teaching material evaluation system includes: a memory storing arrangement information, the arrangement information being information regarding an arrangement of a plurality of components included in the teaching material on the display; a detector configured to detect a viewpoint of a learner on the display for a period in which the teaching material is displayed on the display; and an evaluation unit configured to evaluate the teaching material using a detection result of the viewpoint and the arrangement information.

### BRIEF DESCRIPTION OF THE DRAWINGS

FIG. 1 is an explanatory diagram schematically showing the configuration of a teaching material evaluation system.

FIG. 2 is an explanatory diagram illustrating a manner in which a learner learns using teaching materials.

FIG. 3 is a flowchart showing the contents of the viewpoint detection process.

FIG. 4 is a flowchart showing the contents of the teaching material evaluation process.

FIG. 5 is an explanatory view showing superimposed viewpoint detection result and arrangement information.

### DETAILED DESCRIPTION

### A. First Embodiment

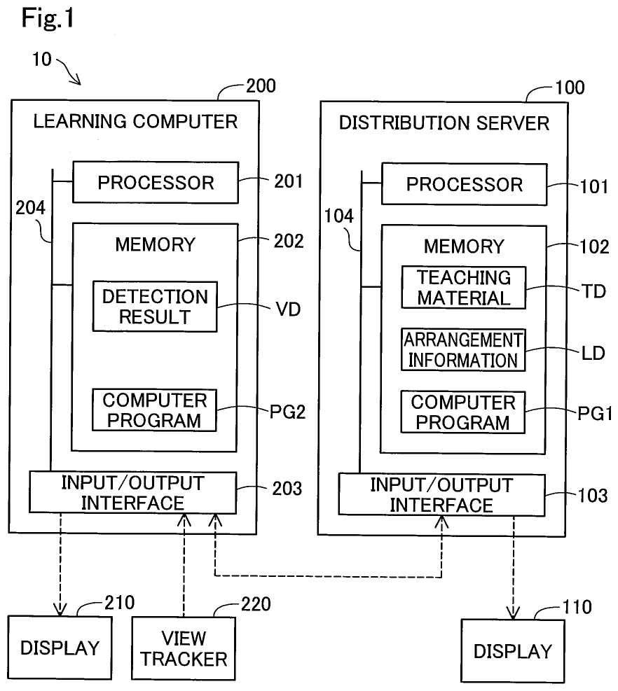

FIG. 1 is an explanatory diagram schematically illustrating a configuration of a teaching material evaluation system 10 according to a first embodiment. The teaching material evaluation system 10 includes a distribution server 100, a learning computer 200, a display 210, and a view tracker 220.

The distribution server 100 performs the distribution of a teaching material TD and the evaluation of the teaching material TD. The distribution server 100 comprises a computer comprising a processor 101, a memory 102, an input/output interface 103, and an internal bus 104. The processor 101, the memory 102, and the input/output interface 103 are bidirectionally communicatively connected via the internal bus 104. In the memory 102, the teaching material TD, an arrangement information LD, and a computer program PG1 are stored. The teaching material TD is an electronic teaching material displayed on a display unit such as a display. Specifically, the teaching material TD is an electronic teaching material in the form of a moving image, or an electronic teaching material in the form of a slide in which the paging is switched by a learner's manipulation. The teaching material TD is composed of plural components. The components are, for example, sentences, diagrams, videos, etc. The arrangement information LD is information on the arrangement of the components constituting the teaching material TD on the display. By executing the computer program PG1, the processor 101 functions as a distribution server 100. The input/output interface 103, a display 110 is connected. The display 110, for example, a liquid crystal display. On the display 110, the evaluation result of the teaching material TD is displayed. The processor 101 is sometimes referred to as an evaluation unit, and the memory 102 is sometimes referred to as a storage unit.

The learning computer 200 is connected to the distribution server 100 via wired or wireless communication. The learning computer 200 displays the teaching material TD distributed from the distribution server 100 and detects the learner's point of view during the time the teaching material TD is displayed. The learning computer 200 comprises a computer comprising a processor 201, a memory 202, an input/output interface 203, and an internal bus 204. The processor 201, the memory 202, and the input/output interface 203 are bidirectionally communicatively connected via the internal bus 204. The memory 202 stores a computer program PG2. The processor 201 executes the computer program PG2 so that the computer functions as the learning computer 200. The input/output interface 203 is connected to the display 210 and the view tracker 220. The display 210, for example, a liquid crystal display. On the display 210, the teaching material TD is displayed. The display 210 is sometimes referred to as a display unit.

The view tracker 220 detects the learner's viewpoint. In this embodiment, the view tracker 220 is fixed to the display 210. The view tracker 220 tracks the movement of the learner's eye by photographing the learner's face with an infrared camera while irradiating the learner's face with infrared light, and detects the learner's viewpoint based on the movement of the eye. In other embodiments, the view tracker 220 may be a type that is fixed to the learner's head rather than a type that is fixed to the display 210. The view tracker 220 may be of a type that tracks the movements of the learner's eyes using electrodes positioned around the learner's eye to detect the learner's viewpoint based on the movements of the eyes. The view tracker 220 is sometimes referred to as a detector.

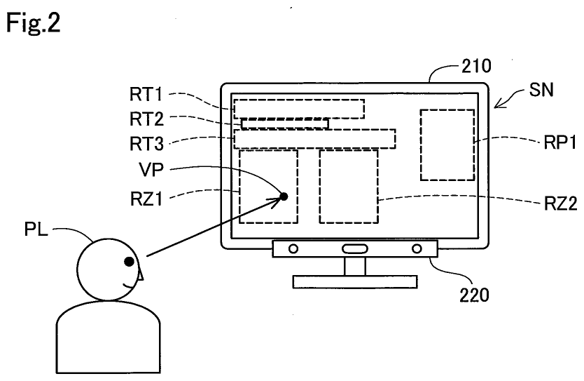

FIG. 2 is an explanatory diagram illustrating a manner in which the learner PL learns using the teaching material TD. In the present exemplary embodiment, the teaching material TD is an electronic teaching material in the form of a moving image with sound, and the learner PL learns by watching the teaching material TD displayed on the display 210. The content of the teaching material TD displayed on the display 210 is referred to as a display screen SN. When the teaching material TD is an electronic teaching material in a moving image format, the display screen SN is switched at a predetermined reproduction position. When the teaching material TD is an electronic teaching material in a slide format, the display screen SN is switched by operating the learner PL.

The display screen SN shown in FIG. 2 includes three sentences, two diagrams, and the image of the instructor who is explaining. In the following explanation, the area in which the components on the display screen SN are displayed is referred to as a component display area. The component display area in which sentences are displayed is called a text display area, and the component display area in which a figure table is displayed is called a figure table display area, while the component display area in which a person such as a lecturer is displayed is called a person display area. When the text display area, the figure table display area, and the person display area are described without being particularly distinguished from each other, the text display area, the figure table display area, and the person display area are referred to as component display areas. The display screen SN shown in FIG. 2 has three text display area RT1 to RT3, two diagram display area RZ1 to RZ2, and one person display area RP1.

The arrangement information LD shown in FIG. 1 includes information about a component occupancy in addition to information about the position and size of the respective component display areas. The component occupancy is the ratio of the sum of the area of each component display area displayed on the display screen SN to the area of the display screen SN. In the present exemplary embodiment, the arrangement information LD further includes information related to the type of component displayed in each component display area and information related to the number of characters of the text displayed in each character display area. The arrangement information LD can be created using a learned model learned by deep learning so as to determine the position, size, and type of the respective component display areas when the teaching material TD is inputted. Placement LD may be created by evaluators who evaluate teaching material TD rather than by the learned model.

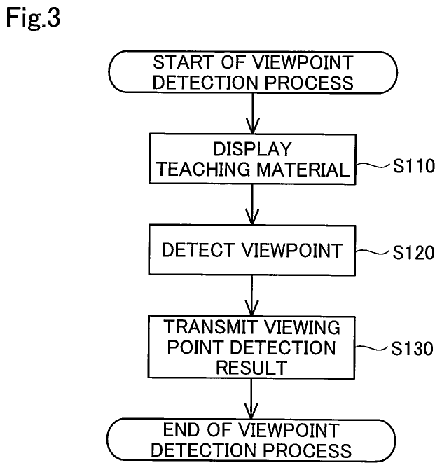

FIG. 3 is a flowchart showing the contents of the viewpoint detection process. The visual point detection process is performed by the processor 201 of the learning computer 200. When the viewpoint detecting process is started, the processor 201 starts displaying the teaching material TD on the display 210 in S110. In the following explanation, the period in which the teaching material TD is displayed is referred to as a teaching material display period.

In S120, the processor 201 detects the viewpoint VP of the learner PL at each time during the teaching material display by using the view tracker 220 and records the position of the viewpoint VP at each time and the display screen SN displayed on the display 210 in the memory 202 in association with each time. When the view tracker 220 of the type that outputs the position of the viewpoint VP at each time and the display screen SN displayed on the display 210 in association with each time is used, the processor 201 may not associate the position of the viewpoint VP at each time with the display screen SN displayed on the display 210 at each time.

In S130, the processor 201 transmits the viewpoint detection result VD recorded in the memory 202 to the distribution server 100. Thereafter, the processor 201 terminates the process.

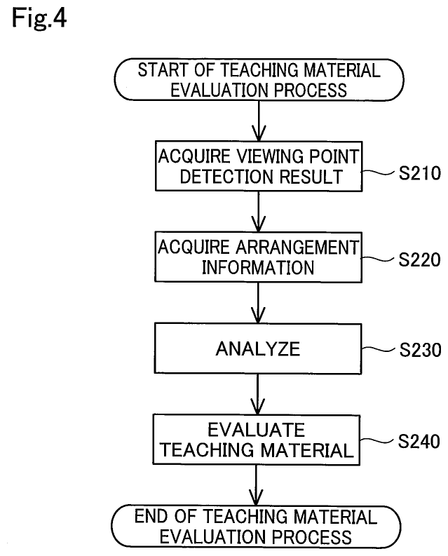

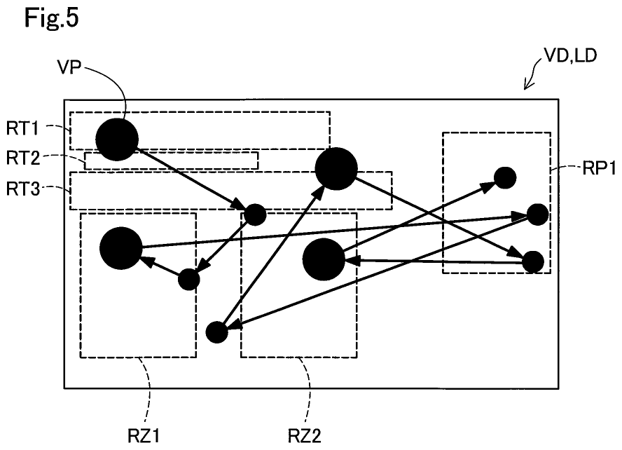

FIG. 4 is a flow chart illustrating the content of the teaching material evaluation process, and FIG. 5 is an explanatory diagram illustrating the viewpoint detection result VD and the arrangement information LD in a superimposed manner. The teaching material evaluation process is executed by the processor 101 of the distribution server 100. When the teaching material evaluation process is started, the processor 101 acquires a arrangement information LD from the memory 102 in S210. The arrangement information LD includes information on the position and size of each component display area on each display screen SN. In S220, the processor 101 obtains the viewpoint detection result VD transmitted from the learning computer 200. The viewpoint detection result VD includes information of the position of the viewpoint VP at each time and information of the display screen SN that was displayed at each time. The order of the S210 and the S220 may be reversed from the order described above.

In S230, the processor 101 performs the analysis using the viewpoint detection result VD and the arrangement information LD. In FIG. 5, the position of the viewpoint VP at every time during the time period in which one display screen SN was displayed is represented by a circle, and the moving path of the viewpoint VP is represented by an arrow. The diameters of the circles represent the length of time that the viewpoint VP remained at the center position of the circles. The diameter of the circle is larger for longer periods when the viewpoint VP stays at the center of the circle. In the present exemplary embodiment, the processor 101 superimposes the viewpoint detection result VD and the arrangement information LD to calculate a gaze time for the respective components. The gaze time is the time that the viewpoint VP had stayed on the component displayed area. Furthermore, the processor 101 computes the area of the movement area of the viewpoint VP on the display screen SN from the movement route of the viewpoint VP.

In S240, the processor 101 evaluates the teaching material TD using the analysis result and causes the display 110 to display the evaluation result. In the present exemplary embodiment, the processor 101 determines whether or not the display screen SN of the teaching material TD is good, makes a negative evaluation to the teaching material TD when the number of the display screen SN determined to be “bad” is one or more, and makes a positive evaluation to the teaching material TD when the number of the display screen SN determined to be “bad” is 0. The processor 101 determines the quality of each display screen SN by using the gaze time for each component displayed on each display screen SN and the ratio of the size of the moving range of the viewpoint

VP to the size of the teaching material TD on the display 210. More specifically, when both the condition A and the condition B described below are satisfied, the processor 101 determines that the display screen SN of the determination object is “good.” When at least one of the following conditions A and B is not satisfied, the processor 101 determines that the display screen SN to be determined is “bad”.

Condition A: The gaze time for each component is within a predetermined reference range for each component.
Condition B: The ratio of the area of the moving area of the viewpoint VP to the area of the display screen SN of the determination target is equal to or more than the reference value determined in advance according to the occupancy ratio of the components for each display screen SN.

If the gaze time for the component is less than the lower limit of the reference range, it is considered that the content of the component is the content that does not attract the interest of the learner PL, so that it is preferable to improve the content of the component so that the content that attracts the interest of the learner PL.

If the gaze time for the component exceeds the upper limit of the reference range, the content of the component is considered to be a content that is hard to be understood by the learner PL, so that it is preferable to improve the content of the component so that the content is easily understood by the learner PL. When the component is a sentence, the upper limit value or lower limit value of the reference range is preferably determined according to the number of characters of the sentence. When the ratio of the area of the moving range of the viewpoint VP to the area of the display screen SN to be determined is less than the reference value, it is preferable to improve the arrangement of the components in the display screen SN to be determined because it is considered that the content of the display screen SN to be determined is not sufficiently viewed by the learner PL, that is, the content of the display screen SN to be determined is not sufficiently transmitted to the learner PL. In another embodiment, the processor 101, instead of determining the quality of each display screen SN, for example, calculates a score on the quality of each display screen SN, may evaluate each display screen SN by relative evaluation using the score. After S240, the processor 101 terminates the process. The method realized by the viewpoint detecting process and the teaching material evaluation process is sometimes referred to as a teaching material evaluation method.

According to the teaching material evaluation system 10 in the present embodiment described above, the processor 101 of the distribution server 100 evaluates the teaching material TD using the viewpoint detection result VD and the arrangement information LD, so that it is possible to grasp whether or not each component of the teaching material TD is viewed by the learner PL. Therefore, teaching material TD can be appropriately evaluated.

In this embodiment, the processor 101 evaluates the teaching material TD according to the gaze time of the learner PL for the respective components. Therefore, the teaching material TD can be appropriately evaluated, because the teaching material TD can be evaluated after grasping the times when the learner PL looks at the components of the teaching material.

In the present exemplary embodiment, the processor 101 evaluates the teaching material TD using the ratio of the area of the moving area of the viewpoint VP to the area of the display screen SN. Therefore, the teaching material TD can be appropriately evaluated, because the teaching material TD can be evaluated after grasping the area where the learner PL viewed the teaching material.

### B. Other Embodiments

(B1) The teaching material evaluation system 10 according to the first embodiment described above includes a plurality of learning computers 200, and the processor 101 of the distribution server 100 may evaluate the teaching material TD using the viewpoint detection result VD acquired from the plurality of learning computers 200.

In this situation, the viewpoint detection result VD of the plurality of learner PL is easily collected. In comparison with the form in which the viewpoint detection result VD of one learner PL is used to evaluate the teaching material TD, it is possible to evaluate the teaching material TD more appropriately by evaluating the teaching material TD using the viewpoint detection result VD of one learner PL.

(B2) In the teaching material evaluation system 10 according to the first embodiment described above, the processor 101 of the distribution server 100 evaluates the teaching material TD using the condition A and the condition B. In contrast, the processor 101 may evaluate the teaching material TD using Condition B without using Condition A or may evaluate the teaching material TD using Condition A without using Condition B.

(B3) In the teaching material evaluation system 10 according to the above-described first embodiment, the distribution server 100 and the learning computer 200 are provided separately. In contrast, the distribution server 100 and the learning computer 200 may be integrated. For example, without the distribution server 100, the teaching material TD and the arrangement information LD are stored in the memory 202 of the learning computer 200, and an assessment of the teaching material TD may be performed by the processor 201 of the learning computer 200. In this case, the learning computer 200 may be referred to as a teaching material evaluation device.

The disclosure is not limited to any of the embodiment and its modifications described above but may be implemented by a diversity of configurations without departing from the scope of the disclosure. For example, the technical features of any of the above embodiments and their modifications may be replaced or combined appropriately, in order to solve part or all of the problems described above or in order to achieve part or all of the advantageous effects described above. Any of the technical features may be omitted appropriately unless the technical feature is described as essential in the description hereof. The present disclosure may be implemented by aspects described below.

(1) In one aspect of the present disclosure, a teaching material evaluation system for evaluating a teaching material displayed on a display is provided. The teaching material evaluation system includes: a memory storing arrangement information, the arrangement information being information regarding an arrangement of a plurality of components included in the teaching material on the display; a detector configured to detect a viewpoint of a learner on the display for a period in which the teaching material is displayed on the display; and an evaluation unit configured to evaluate the teaching material using a detection result of the viewpoint and the arrangement information.

According to the teaching material evaluation system of this form, the teaching material is evaluated using the detection result and the arrangement information of the learner's viewpoint, so that the teaching material can be appropriately evaluated.

(2) According to the teaching material evaluation system of the above aspect, the evaluation unit may be configured to evaluate the teaching material in accordance with time during which the viewpoint stays on each of the components.

According to the teaching material evaluation system of this form, the teaching material can be evaluated in accordance with the time when the learner's viewpoint stays on each component, so that the teaching material can be appropriately evaluated.

(3) According to the teaching material evaluation system of the above aspect, the evaluation unit may be configured to evaluate the teaching material using a size of each of the components on the display and a size of a movement range of the viewpoint.

According to the teaching material evaluation system of this form, the teaching material can be evaluated using the size of each component on the display unit and the size of the moving range of the learner's viewpoint, so that the teaching material can be appropriately evaluated.

(4) According to the teaching material evaluation system of the above aspect, the evaluation unit may be configured to evaluate the teaching material using a detection result of the viewpoint of a plurality of learners and the arrangement information.

According to the teaching material evaluation system of this form, it is possible to evaluate the teaching material more appropriately than the form of evaluating the teaching material using the detection result of the viewpoint of one learner.

(5) In one aspect of the present disclosure, a teaching material evaluation method for evaluating a teaching material displayed on a display is provided. The teaching material evaluation method includes: preparing arrangement information, the arrangement information being information regarding an arrangement of a plurality of components included in the teaching material on the display; detecting a viewpoint of a learner on the display for a period in which the teaching material is displayed on the display; and evaluating the teaching material using a detection result of the viewpoint and the arrangement information.

According to the teaching material evaluation method of this form, the teaching material can be appropriately evaluated because the teaching material is evaluated using the detection result and the arrangement information of the learner's viewpoint.

The present disclosure can also be realized in various forms other than the teaching material evaluation system and the teaching material evaluation method. For example, it can be realized in the form of a teaching material evaluation device, a teaching material evaluation program, and the like. The arrangement information can be created, for example, using deep learning.

What is claimed is:

1. A teaching material evaluation system for evaluating a teaching material displayed on a display comprising:
a memory storing arrangement information, the arrangement information being information regarding an arrangement of a plurality of components included in the teaching material on the display;
a detector configured to detect a viewpoint of a learner on the display for a period in which the teaching material is displayed on the display; and
an evaluation unit configured to evaluate the teaching material using a detection result of the viewpoint and the arrangement information.

2. The teaching material evaluation system according to claim 1, wherein
the evaluation unit is configured to evaluate the teaching material in accordance with time during which the viewpoint stays on each of the components.

3. The teaching material evaluation system according to claim 1, wherein
the evaluation unit is configured to evaluate the teaching material using a size of each of the components on the display and a size of a movement range of the viewpoint.

4. The teaching material evaluation system according to claim 1, wherein
the evaluation unit is configured to evaluate the teaching material using a detection result of the viewpoint of a plurality of learners and the arrangement information.

5. A teaching material evaluation method for evaluating a teaching material displayed on a display comprising:
preparing arrangement information, the arrangement information being information regarding an arrangement of a plurality of components included in the teaching material on the display;
detecting a viewpoint of a learner on the display for a period in which the teaching material is displayed on the display; and
evaluating the teaching material using a detection result of the viewpoint and the arrangement information.
